(19) United States
(12) Patent Application Publication
(10) Pub. No.: US 2022/0245562 A1
(43) Pub. Date: Aug. 4, 2022

(54) SYSTEM FOR CLEANING AN ENVIRONMENT

(71) Applicant: Vorwerk & Co. Interholding GmbH, Wuppertal (DE)

(72) Inventors: Andrej MOSEBACH, Unna (DE); Henning HAYN, Hilden (DE)

(73) Assignee: Vorwerk & Co. Interholding GmbH, Wuppertal (DE)

(21) Appl. No.: 17/591,644

(22) Filed: Feb. 3, 2022

(30) Foreign Application Priority Data
Feb. 4, 2021 (DE) 10 2021 102 654.7

(51) Int. Cl. G06Q 10/06; A47L 11/40

(52) U.S. Cl. CPC G06Q 10/063114; G06Q 10/06314; A47L 2201/06; A47L 2201/04; A47L 11/4011

(57) ABSTRACT

A system for cleaning an environment has least one self-propelled cleaning device, which has a status detection device, at least one environmental detection device, a computing device for defining a working activity to be performed as a function of the detected environmental parameter and/or detected operating status, and a database.

### CROSS REFERENCE TO RELATED APPLICATIONS

Applicant claims priority under 35 U.S.C. § 119 of German Application No. 10 2021 102 654.7 filed Feb. 4, 2021, the disclosure of which is incorporated by reference.

### BACKGROUND OF THE INVENTION

### 1. Field of the Invention

The invention relates to a system for cleaning an environment, with at least one self-propelled cleaning device, which has a status detection device for detecting an operating status of the cleaning device, at least one environmental detection device for detecting an environmental parameter of the environment, a computing device for defining a working activity to be performed as a function of the detected environmental parameter and/or the detected operating status, and a database for storing the working activity to be performed.

### 2. Description of the Related Art

Systems of the aforementioned kind are known in prior art. The system has one or several autonomous cleaning devices, in particular so-called cleaning robots. For example, the latter involve floor processing devices, in particular suction cleaning devices, with a blower for vacuuming dust and dirt from a surface to be cleaned, or wet cleaning devices with a wiping element for damp mopping a surface to be cleaned.

The cleaning device normally has a status detection device, with which a current operating status of the cleaning device can be detected. For example, the operating status can be the charge level of a battery, a blocked state of a drive wheel of the cleaning device, or a blocked state of a cleaning element, for example of a rotating cleaning roller or a swinging wiping element. Another important operating status involves the occurrence of a so-called accident situation, for example, in which the cleaning device is stuck in a partial environmental area, e.g., between obstacles standing close to each other, on a door threshold, a carpet edge, or the like. The cleaning device can further have a dirt sensor as the environmental detection device of the system, which is set up to detect a contamination status of a partial environmental area of the environment. However, the environmental detection device need not necessarily be part of the cleaning device, but can rather also be a detection device designed separately from the cleaning device. As an alternative to the aforementioned contamination, the environmental detection device can also detect other environmental parameters, for example the presence of people in the environment, an activity state of a lighting system, an opening state of windows and/or doors, and the like.

As known, the detected environmental parameters as well as the operating status of the cleaning device can be used to define an activity plan, which contains working activities to be performed. For example, the activity plan can specify a cleaning operation in a specific partial environmental area, a trip to a charging station, or the like.

### SUMMARY OF THE INVENTION

Even though the systems for cleaning an environment known in prior art have proven themselves, the object of the invention is to optimally clean in particular a commercial or industrial environment as well, wherein a plurality of working activities are to be performed, a portion of which are normally also to be performed manually by cleaning personnel, for example the emptying of wastebaskets, resupply of consumables to locations in the environment provided for this purpose, and so on. In particular, the object of the invention is to make planning the distribution of working tasks completely automatic, so that the decision as to when which activities are to be performed need not be made manually, for example by personnel of a cleaning company.

In order to achieve this object, it is proposed that the system have an input-output interface that communicates with the computing device, and be set up to receive at least one work order relating to a working activity to be performed from a user of the system, wherein the computing device is set up to analyze a totality of working activities defined based upon the environmental parameters and/or operating status and of work orders received via the input-output interface with respect to a performance time for the working activities to be performed, and to generate a work plan that defines working activities to be manually performed by a user in a specific time period, and output it to the user by means of the input-output interface.

According to the invention, the computing device of the system is now designed to analyze the plurality of different working activities to be performed, in particular to also evaluate them as to their time urgency, and automatically generate a work plan, which provides a user with information about which working activities are to be performed within a specific time period, for example on a specific day, within the next two hours, or in other time windows, so that the user need only work according to the generated work plan. The user him or herself no longer has to decide which working activities are to be performed next.

In particular, it is proposed that the computing device be set up to filter the totality of working activities, and define a first activity quantity, which comprises at least one working activity that can be automatically performed by the at least one cleaning device, and a second activity quantity, which comprises at least one working activity to be performed exclusively manually by a user. The computing device is thus set up to completely automatically and independently determine which working activities can be performed exclusively manually by a user, because the cleaning devices integrated into the system are either not suitable for automatically performing the cleaning activity, or because the situation does not allow one of the cleaning devices to perform this working activity, for example because an operating status of the cleaning device currently indicates an error, the cleaning device is basically not designed to perform the working activity, or the like. Likewise, the computing device is designed, based upon working activities that can be automatically performed by one or several of the cleaning devices, to detect when the cleaning device has a corresponding capability or design and a corresponding current standby state (operating state). As a consequence, the system enables a fully automated analysis of planned working activities and of work orders manually input into the system, as well as a classification into manual and automatic activities. The work plan output via the input-output interface of the system can here be divided into manual working activities on the one hand, and automatic working activities on the other. In addition, however, it is also possible that the work plan effect a priority time weighting of the working activities, and thus contain the working activity to be performed first as the first, regardless of whether it here involve a working activity to be manually performed or automatically performed. However, it is especially advantageous that the work plan contain working activities to be performed exclusively manually, which are to be performed manually by a user. Without any prior information of the user, the computing device can directly convert the automatically performable working activities into a control command for a cleaning device, wherein the control command preferably only leads to the performance of the working activity once the performance time defined for this purpose has been reached.

In addition, it is proposed that the database of the system have a file that stores reference activities for working activities to be performed manually and reference activities for automatically performable working activities, wherein the computing device is set up to compare a working activity to be performed with the stored reference activities, and given a correlation between the working activity and one of the reference activities, infer a working activity to be performed manually or an automatically performable working activity. For example, the emptying of garbage cans, wastebaskets and the like can be provided as a reference activity for a working activity to be performed manually. Working activities to be performed manually further include filling up consumables in the environment, for example refilling soap, copy paper, coffee capsules, toilet paper, cleaning agents and the like. The working activities to be manually performed can further also include maintenance and/or repair activities to be performed on a cleaning device, for example changing out a cleaning element, cleaning a filter, carrying the cleaning device to another floor, and the like. For example, reference activities for automatically performable working activities can be those that describe an activity for which one of the cleaning devices of the system is designed, for example a vacuuming activity or mopping activity in an area of the environment free of obstacles, the transfer of collected dust and dirt to a base station provided for that purpose, the receiving of accessories or cleaning agents from a base station.

In addition, it is proposed that the computing device be set up to prompt the user to do a working activity to be exclusively performed manually by means of the input-output interface. In particular, as soon as a starting time has been reached for a working activity, the user can be informed that the manual working activity must now be performed. In an especially simple form, this prompt takes place by way of the work plan, which among other things can also have a plurality of additionally planned working activities. In addition, however, it is also possible for the user to be specifically informed only about a single working activity to be manually performed. This can then take place independently of a work plan, for example by indicating a prompt on a display, by means of voice output, or the like.

It can further be provided that the computing device be set up to adjust a second working activity of the cleaning device to be automatically performed as a function of an environmental parameter that was changed based upon a first working activity performed by a user. For example, if the user manually intervenes in an environment, in particular if this activity is not prescribed by the defined work plan, it may be necessary to adjust the additional, chronologically ensuing working activities defined in the work plan, for example so as not to duplicate the performance of a cleaning task. For this purpose, the environmental detection device detects relevant environmental parameters of the environment, for example a contamination state of the environment, a fill level of consumables, and the like. As soon as it has been determined that a working activity has already been performed, the work plan defined beforehand can be adjusted in such a way as to delete the corresponding working activity from the work plan, or define another duration, work intensity or repetition frequency for this working activity. Likewise, however, a manual working activity can be deleted from the work plan or adjusted if it is determined that the user has already performed the working activity beforehand on an unplanned basis. For example, this can be advantageous if several cleaning personnel are active in an environment, and their behavior is not coordinated, i.e., does not follow the defined work plan.

The computing device of the system can further be set up to prompt a working activity to be performed manually by a user as a function of the current operating status of the cleaning device, by virtue of the computing device having the input-output interface output a prompt to perform the manual activity. This performance relates to working activities to be manually performed, which are contingent upon the current operating status of the cleaning device. For example, the operating status can involve an accident status or error status of the cleaning device that requires assistance by the user, for example to free the cleaning device from a stalled situation, carry the cleaning device to another location, for example a charging station given a completely discharged battery of the cleaning device, or to another floor that the cleaning device cannot reach on its own. For example, another operating status of the cleaning device that likewise requires a manual intervention by the user can involve a maintenance activity, such as cleaning a filter, dust collection container or cleaning element, refilling a cleaning liquid, or the like. In particular, the input-output interface can output a prompt for a maintenance activity optically or acoustically, in particular also independently of the defined work plan.

In particular, the working activity to be performed manually can thus be a service activity for the cleaning device, in particular providing consumables in the environment or transferring consumables to the cleaning device, receiving material collected by the cleaning device in the environment, freeing the cleaning device from a stalled position, carrying the cleaning device to a base station, changing or cleaning a component of the cleaning device.

In addition, the working activity to be performed manually can be a cleaning activity for cleaning the environment, in particular cleaning an aboveground surface and/or cleaning a surface not accessible to the cleaning device. These working activities to be performed manually relate to cleaning activities that the at least one cleaning device of the system cannot perform, for example because the corresponding environmental area in which the working activity is to be performed cannot be reached by the cleaning device. In particular, this relates to aboveground surfaces, such as baseboards, shelving, or the like.

Another embodiment can provide that the environmental detection device be set up to detect a currently transpiring use of at least one location in the environment as the environmental parameter. If one or several partial environmental areas of the environment are being used, a cleaning requirement in the respective partial environmental area can be inferred. If a partial environmental area was not even used at all, there need be no cleaning in this partial environmental area. In contrast, partial environmental areas that have been used long and/or intensively can preferably be considered in the work plan, so that the latter are cleaned first in time or at a higher performance frequency.

In particular in this conjunction, it is proposed that the environmental detection device have a presence sensor and/or a motion sensor and/or a continuity sensor and/or a location sensor for mobile devices. The use data thus contain information about a presence of one or several people in a partial environmental area of the area equipped with the environmental detection device, wherein a presence can be characterized by the presence of a person, a movement by the person through the partial environmental area, or a movement by a person into the partial environmental area or out of the partial environmental area. For example, the environmental detection device can have a motion sensor of the kind known for lighting devices with a motion sensor. In addition, the environmental detection device can also have a heat sensor, for example an infrared sensor, which can detect the presence of a person in a partial environmental area. Light barriers can also be used in the area of an access door to a specific partial environmental area, for example. In addition, it is possible to locate mobile devices that a person usually carries with them. For example, such mobile devices can be mobile phones, tablet computers or the like. A so-called “heatmap” can be generated based upon the location data of the mobile terminals, which contains a traveling route of the respective person through the environment. The environmental detection device can have separately designed sensors placed in one or several partial environmental areas of the environment, or sensors that are integrated into other objects of the environment. For example, a sensor can be integrated into a lamp, which is part of an automated light controller of offices, for example.

### BRIEF DESCRIPTION OF THE DRAWINGS

The invention will be described in more detail below based upon exemplary embodiments. Shown on:

FIG. 1 is part of a system according to the invention for cleaning an environment;

FIG. 2 is a layout of an environment with a system for cleaning an environment;

FIG. 3 is a file with a plurality of work orders transmitted by a user to the system;

FIG. 4 is a file with information allocated to cleaning devices of the system;

FIG. 5 is a file with a maintenance table for a cleaning device;

FIG. 6 is a file with working activities to be performed as a function of a use of a specific location of the environment;

FIG. 7 is a work plan with working activities to be performed manually.

### DETAILED DESCRIPTION OF PREFERRED EMBODIMENTS

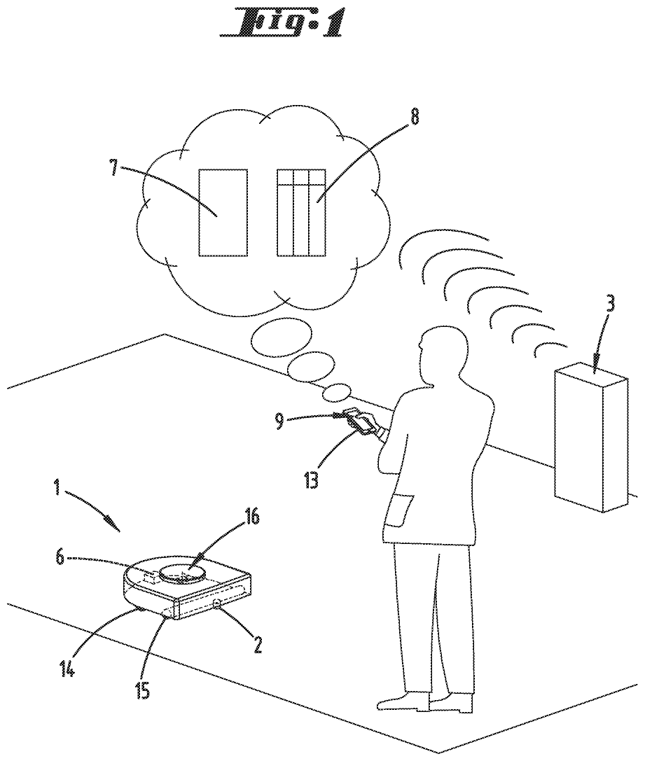

FIG. 1 exemplarily shows a cutout of a system for cleaning an environment. The system contains at least one cleaning device 1 (shown here strictly by way of example). The system can have a plurality of additional cleaning devices 1. The cleaning devices 1 can be similar or different in design. In addition, the system has a computing device 7 and a database 8 which the computing device 7 accesses. The computing device 7 and the database 8 are here exemplarily formed centrally in a remote server, in particular a so-called cloud server. The cleaning device 1 or the cleaning devices 1 of the system have communication devices (not shown) for establishing a communications link with the computing device 7 of the system. In particular, the respective cleaning device 1 can have a WLAN module. Other wireless communication techniques are also possible for data transmission. The system further has an external terminal 13, with which the user of the system can make inputs. In particular, the external terminal 13 can be a mobile terminal, for example a mobile phone, a tablet computer, or the like. The external terminal 13 has an input-output interface 9, for example a touchscreen, which can receive inputs from the user or initiate outputs to the user. This system further has at least one environmental detection device 2, 3, 4, 5, which is designed to detect an environmental parameter 17 of the environment. This will be explained further below.

For example, the at least one cleaning device 1 is here designed as an autonomous suction robot. The cleaning device 1 has motor-driven wheels 14, as well as one or several cleaning elements 15, which preferably can likewise be motor driven. For example, the cleaning device 1 here has a cleaning element 15 designed as a cleaning roller, which rotates around an essentially horizontal axis, and rolls onto a surface to be cleaned. In addition, the cleaning device 1 has an environmental detection device 2, which is set up to detect an environmental parameter 17 of the environment. For example, the environmental parameter 17 here involves a contamination level of a surface to be cleaned. A status detection device 6 of the cleaning device 1 is designed to detect an operating status 18 of the cleaning device 1. For example, the operating status 18 can be a blockade of the wheel 14 or the cleaning element 15, a charging status of an undepicted battery of the cleaning device 1, a stalled state of the cleaning device 1 at a location 22 of the environment, for example a stalling between tightly adjacent obstacles or the like. In order for the cleaning device 1 to automatically navigate and travel in the environment, the cleaning device 1 has a navigation device 16, which is set up to detect properties of the environment, and use the latter for navigating and self-localizing the cleaning device 1 in the environment. For example, the navigation device 16 can have a distance measurement device, e.g., an optical measurement system, in particular a triangulation system, which is suitable for measuring distances to obstacles, and a data processing device, which is set up to generate a layout of the environment based upon the measured distance values, in particular in the form of an area map.

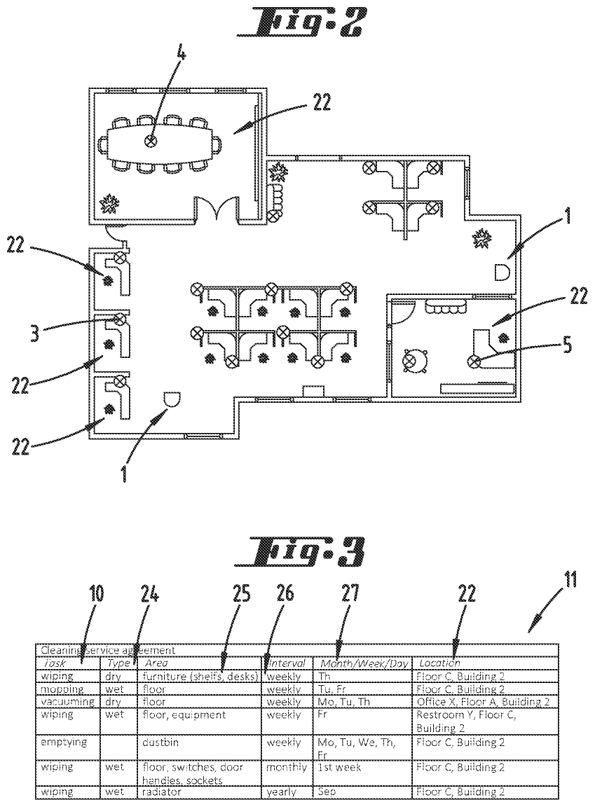

FIG. 2 exemplarily shows a layout of an environment that is cleaned by a system according to the invention. The system contains several cleaning devices 1 and, apart from the device-specific environmental detection device 2 of the cleaning devices 1, several additional environmental detection devices 3, 4, 5, which can detect environmental parameters 17 of the environment. The environmental detection devices 3, 4, 5 are here set up to determine a user of the location 22 allocated to the respective environmental detection device 3, 4, 5 as environmental parameters 17, for example by detecting a presence of a person, a movement at the respective location 22, or a presence of a tracked mobile device at the respective location 22. Furthermore, the environmental detection device 3, 4, 5 can alternatively or additionally also have a continuity sensor, which monitors access to the respective location 22. A cleaning requirement at the respective location 22 can then be derived based upon the determined use of the respective location 22, wherein locations 22 at which no use has taken place need accordingly also not be cleaned. On the other hand, if it is determined that a location 22 was used or at least that people were present there, a cleaning of this location 22 can advantageously take place.

A plurality of different working activities 10 may be necessary in the environment, which can be performed by an autonomous cleaning device 1 and/or manually by users or cleaning specialists. In particular in the area of commercial or industrial environments, for example office complexes, it is known to commission a professional cleaning company to perform diverse working activities 10. For example, these working activities 10 include cleaning a floor surface at various locations 22 of the environment, cleaning aboveground surfaces, such as furniture surfaces, baseboards, or windowsills. Working activities 10 to be performed further include emptying wastebaskets and garbage cans, refilling consumables, for example soap or toilet paper in a WC room, or maintenance activities on one or several cleaning devices 1, provided these are due. For example, maintenance activities include cleaning or replacing a filter of the cleaning device 1, emptying a dust collection container of the cleaning device, or the like.

Depending on the configuration of the cleaning devices 1 used in the system, working activities 10 can be performed fully automatically by the cleaning devices 1, or require a manual action on the part of a user or cleaning person. The computing device 7 of the system can especially preferably be designed to check whether a working activity 10 to be performed can be performed by one or several of the cleaning devices 1, or whether a manual intervention by a human is required. To this end, the database 8 of the system that is accessed by the computing device 7 can have a plurality of reference activities, for example, which serve for comparison with working activities 10 to be performed. The computing device 7 can thus compare a working activity 10 to be performed with the plurality of defined reference activities, and given a match with a reference activity that indicates a working activity 10 to be performed exclusively manually, infer that this working activity 10 must be performed manually by a human. Accordingly, a user of the system can be informed about the requirement for a manual performance, for example with the help of the external terminal 13, the input-output interface 9 of which can be used to output this information. In particular, the input-output interface 9, provided it has a display function, can indicate a work plan 12 (see FIG. 7), which contains various working activities 10 for the user or cleaning personnel. This will be discussed in even more detail later.

In order to implement the invention, a user of the system initially inputs a plurality of work orders 11 into the external terminal 13 according to FIG. 3, for example, so as to transmit the work orders 11 to the computing device 7 of the system. Each work order 11 contains a specific working activity 10, which is to be performed at a defined location 22 of the environment. The work order 11 is characterized in more detail by various parameters, specifically by the working activity 10 to be performed, for example here specifically mopping or vacuuming a floor surface or emptying a garbage can. A specific working activity 10 can further be characterized by a subtype 24, for example by an indication like “wet” or “dry”, thereby describing in more detail whether mopping is to take place wet or dry. In addition, a separate column also indicates an area 25 at a location 22 of the environment for performing the working activity 10, for example furniture, floor surfaces, garbage cans, light switches, or other objects to be cleaned. Furthermore, a respective repetition frequency 26 and a performance time 27 are indicated. For example, a repetition frequency 26 is weekly, monthly, annually. The indicated performance time 27 can be a specific weekday, a specific week in each month, a month or also a date and/or time of day. The last column of the depicted table here indicates the respective location 22 for performing the working activity 10. For example, the work orders 11 as a whole can be part of a service agreement with a professional cleaning company, which describes precisely when which cleaning activity is to be performed at which location 22.

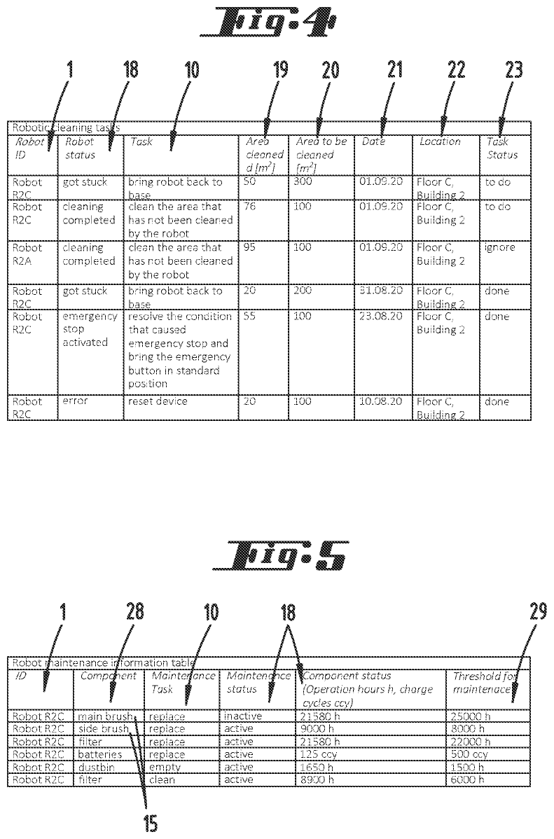

FIG. 4 shows a table with data collected about the environmental parameters 17 of the environment or operating status 18 of the cleaning devices 1 operating in the system. For this purpose, the computing device 7 collects data from various sources, for example the environmental detection devices 2 of the cleaning devices 1 themselves, and possibly also from external environmental detection devices 3, 4, 5, which can optionally be used in the system. The table depicted on FIG. 4 is likewise filed in the database 8 of the system, and contains working activities 10 that require a manual intervention by a human, for example maintenance activities to be performed on the cleaning devices 1.

For example, the status detection device 6 of the respective cleaning device 1 monitors whether a working activity 10 has not yet, partially, or completely been performed, whether an error status of the cleaning device 1 is present, or the like. For example, the status detection device 6 can determine when an accident situation is present, i.e., the cleaning device 1 is stalled at a location 22 of the environment, for example, or whether a wheel 14 or a cleaning element 15 is blocked, whether a charge status of a battery of the cleaning device 1 is sufficient for completely performing a working activity 10, or the like. If a detected operating status 18 is an error status of the cleaning device 1, a working activity 10 can as a result once again be required, which necessitates a manual participation by a human. For example, an operating status 18 of the cleaning device 1 can require that a user bring the cleaning device 1 to another location, for example to a location 22 free of obstacles or a location 22 of a charging station for the battery of the cleaning device 1. For example, every time that an error status of a cleaning device 1 is present, a working activity 10 has ended, or an accident situation exists, an entry is made in the table depicted on FIG. 4. This in turn yields new working activities 10 to be performed. For example, the exemplarily depicted top working activity 10 on the table lists that the robot “R2C” is stalled (operating status 18), which results in the working activity 10 “bring the robot back to the base station”. It is further recorded that the cleaning device 1 had already processed a cleaned surface 19 of 50 m² before the accident case arose. The entire overall surface 20 to be cleaned measures 300 m², however. Additionally filed in the table are the date 21 of the table entry, the respective location 22 at which the working activity 10 is to be performed, as well as the work status 23. The work status 23 “to do” here indicates that the working activity 10 must still be completed, since 250 m² of the 300 m² overall surface have not yet been processed.

FIG. 5 shows an additional table, which likewise is filed in the database 8 of the system. This table has maintenance activities to be performed on one or several cleaning devices 1. For example, the usual maintenance activities on a cleaning device 1 include maintenance on components 28 such as the primary brush, side brush, filter, battery, dust container, or others. The maintenance operations are working activities 10 having to do with changing or cleaning a component 28. In order to formulate the working activities 10, the computing device 7 has corresponding information as to the service life of the components 28 or the contamination level of a component 28, e.g., such as a dust container or a filter. For example, the second line of the table indicates that the cleaning element 15 “side brush” of the “R2C” robot must be replaced after an operating period (reference value 29) of 8000 hours. However, the operating status 18 of the cleaning device 1 already indicates an operating time of “9000 hours”, so that the operating status 18 (maintenance status) is set to “active”. This means that the cleaning element 15 must be replaced as soon as possible. For example, the reference values 29 can be defined by a user of the system. To this end, for example, the user can make corresponding entries by means of an application installed on his or her external terminal 13. As soon as a user has serviced the component 28 of the cleaning device 1 to be replaced, the operating status 18 is correspondingly reset to “inactive”. The reset can likewise take place manually via the application. Alternatively, however, a detection device of the cleaning device 1 can automatically determine when the maintenance activity was successfully performed. Based upon the kept table, the working activities 10 to be performed for servicing the cleaning devices 1 are continuously updated.

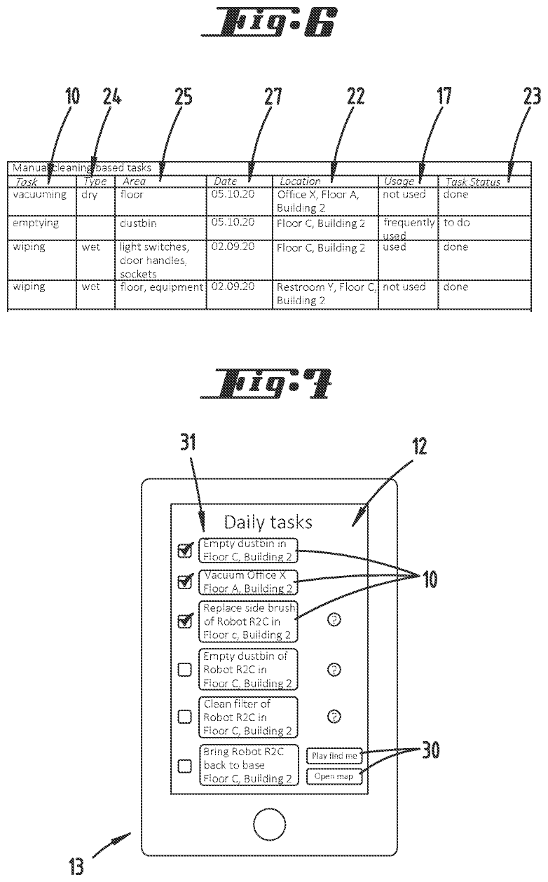

FIG. 6 shows an additional table, which indicates working activities 10 that are required as a function of an environmental parameter 17 detected by an environmental detection device 2, 3, 4, 5. According to this embodiment, environmental detection devices 2, 3, 4, 5 of the system, for example dirt sensors, motion sensors, closing sensors on doors or windows, sensors that monitor an activation of a light switch or the like, can serve to monitor a contamination or use of specific locations 22 of the environment that are allocated to the sites of the environmental detection device 2, 3, 4, 5. In modern office environments, for example, use is made of a lighting controller to detect a presence of people within specific rooms. For example, the automatic lighting controller is achieved by motion sensors, which provide necessary information about what locations 22 were actually used, and should thus be cleaned, what consumables are to be replaced at a specific location 22, whether doors or windows must be closed, or the like. In further detail, an environmental detection device 2, 3, 4, 5 or a computing device 7 of the system can also draw conclusions from the above as to whether a specific usage occurs routinely. The environmental parameter 17 recorded in the table indicates whether the corresponding location 22 of the environment was used or not. Locations 22 that have the environmental parameter 17 “used” and were not yet cleaned receive the work status 23 “to do” for the corresponding working activity 10, for example vacuuming a location 22, emptying a garbage can, or others.

Working activities 10 for cleaning devices 1 as well as working activities 10 that must be performed manually by a cleaning person can then be defined based upon the tables on FIGS. 3 to 6 shown above. If an error status or accident status of a cleaning device 1 is present, the working activity 10 is preferably always set to “to do”, so that it is defined that this working activity 10 must still be performed. If working activities 10 have begun but not been fully concluded, it can be determined whether to set the status to “to do” or “done” depending on the degree to which the working activity 10 has been completed. For example, if a cleaning device 1 has ended a cleaning operation, but the actually cleaned surface 19 is smaller than an overall surface 20 to be cleaned, the status can be set to “to do”, for example, if a specific minimum percentage has not been reached, for example less than 95 percent of the overall surface 20 has been cleaned. In contrast, if more than 95 percent of the surface has been cleaned, the status is “done” (“done”). With regard to the pending maintenance activities, a user can preferably determine themselves whether they wish to be informed about pending maintenance activities or not. For example, only if a notification is actively requested can the user be informed about a corresponding working activity 10 to be performed by way of their external terminal 13.

For example, from the quantity of working activities 10 to be performed in a specific time period within the environment, the computing device 7 of the system can filter out those working activities 10 that must be performed manually by a user or cleaning personnel of the system. A work plan 12 according to FIG. 7 can then be generated for these working activities 10, which only contains the working activities 10 to be performed by a human. However, it is of course also possible to likewise list working activities 10 to be performed automatically, because a user must activate a start button on a cleaning device 1 to initialize the working activity, for example. The work plan 12 is generated from the plurality of working activities 10 that have the work status 23 “to do/to do”. The work plan 12 can further be defined as relates to people, i.e., only those working activities 10 are listed that can be performed by a specific person. Accordingly, authorizations for the users of the system can be filed in the database 8.

A working activity 10 is preferably removed from the work plan 12 as soon as the working activity 10 has been completed. The user can mark a working activity 2 as completed via the input-output interface 9 of their external terminal 13. The working activities 10 exemplarily listed on the input-output interface 9 on FIG. 7 could additionally be listed separately by type of working activity 10, for example by working activities 10 to be performed automatically and working activities 10 to be performed manually. Furthermore, additional activating elements 30 can be shown on the display of the external terminal 13, for example, which serve to retrieve specific information for the user. With regard to one or several prompts 31 that relate to a working activity 10 to be performed, for example, the user can activate an activating element 30 “play find me” or “open map”, so that information is output that provides the user an indication as to where the cleaning device 1 is currently located, for example. For example, after the corresponding activating element 30 has been pressed, the cleaning device 1 can make a sound that allows the use to find the cleaning device 1. In addition, an area map can also be opened, which displays a current location 22 of the cleaning device 1 in the environment to the user. In addition, information about how a component 28 can be cleaned or replaced within the framework of a maintenance activity can also be displayed. In addition, the prompts 31 can also be weighted in such a way as to be provided with a priority notice. For example, the prompts 31 can be indicated in a specific color according to a stoplight system, e.g., red for urgent, yellow for a somewhat urgent, and green for working activities 10 that are to be performed occasionally, but are not especially urgent. Working activities 10 to be performed based upon an error or an accident situation of the cleaning device 1 can here be indicated as urgent, routine working activities 10 for maintenance purposes can be marked as working activities 10 to be occasionally performed. Usual cleaning activities can further be defined as somewhat urgent.

### LIST OF REFERENCE NUMERALS

1 Cleaning device
2 Environmental detection device
3 Environmental detection device
4 Environmental detection device
5 Environmental detection device
6 Status detection device
7 Computing device
8 Database
9 Input-output interface
10 Working activity
11 Work order
12 Work plan
13 External terminal
14 Wheel
15 Cleaning element
16 Navigation device
17 Environmental parameter
18 Operating status
19 Cleaned surface
20 Overall surface
21 Date
22 Location
23 Work status
24 Subtype
25 Area
26 Repetition frequency
27 Performance time
28 Component
29 Reference value
30 Activating element
31 Prompt

What is claimed is:

1. A system for cleaning an environment, comprising:
at least one self-propelled cleaning device, which has a status detection device configured for detecting an operating status of the cleaning device;
at least one environmental detection device configured for detecting a currently ongoing use of at least one location of the environment;
a computing device configured for defining a working activity to be performed as a function of the use of the at least one location of the environment detected by the environmental detection device and the operating status detected by means of the status detection device;
a database configured for storing the working activity to be performed;
an input-output interface that communicates with the computing device, and is configured to receive at least one work order relating to a working activity to be performed from a user of the system;
wherein the computing device is configured to:
analyze a totality of working activities defined based upon the detected use and the detected operating status and the work orders received via the input-output interface with respect to a performance time for the working activities to be performed, specifically to filter the totality of working activities and define a first activity quantity, which comprises at least one working activity that can be automatically performed by the at least one cleaning device, and a second activity quantity, which comprises at least one working activity to be performed exclusively manually by a user, completely automatically and independently determine which working activities can be performed exclusively manually by a user, because the cleaning devices integrated into the system are either not suitable for automatically performing the cleaning activity, or because the situation does not allow one of the cleaning devices to perform this working activity, and
generate a work plan that defines working activities to be manually performed by a user in a specific time period, and output the work plan to the user by means of the input-output interface.

2. The system according to claim 1, wherein the computing device is configured to evaluate the plurality of different working activities to be performed as to their time urgency, and based thereupon to generate the work plan, so that the user need only work according to the generated work plan, and no longer has to decide which working activity is to be performed next.

3. The system according to claim 1, wherein the computing device is configured, based upon working activities that can be automatically performed by one or several of the cleaning devices, to detect when the cleaning device has a corresponding capability or design and a corresponding current operating state.

4. The system according to claim 1, wherein the work plan contains working activities to be performed exclusively manually, which are to be performed manually by a user.

5. The system according to claim 1, wherein, without any prior information to the user, the computing device is configured to directly convert the automatically performable working activities into a control command for a cleaning device, wherein the control command preferably only leads to the performance of the working activity once the performance time defined for this purpose has been reached.

6. The system according to claim 1, wherein the computing device is configured to adjust a second working activity of the cleaning device to be automatically performed as a function of an environmental parameter that was changed based upon a first working activity performed manually by a user, so that, if the user manually intervenes in an environment and manually performs a working activity not prescribed by the defined work plan, a chronologically ensuing work activity defined in the work plan is adjusted, so as not to duplicate the performance of a work activity, wherein the computing device is configured to determine that a work activity has already been performed, and to then adjust the work plan defined beforehand in such a way as to delete the corresponding work activity from the work plan, or define another duration, work intensity or repetition frequency for this working activity.

7. The system according to claim 1, wherein the working activity to be performed manually is a cleaning activity for cleaning an aboveground surface or a surface not accessible to the cleaning device.

8. The system according to claim 1, wherein the computing device is configured not to define any working activity in a partial environmental area that was not even used at all, and to give priority consideration in the work plan to a partial environmental area that was used long or intensively, so that a working activity in the partial environmental area is performed first in time or at a higher performance frequency.

9. The system according to claim 1, wherein the work order input by the user via the input-output interface contains a specific working activity to be performed at a defined location of the environment, wherein the work order is characterized by different parameters selected from the group: type of working activity, mopping or vacuuming a floor surface, emptying a garbage can, wet cleaning, dry cleaning, area at a location of the environment for performing the working activity, specifically furniture to be cleaned, floor surfaces, garbage cans, light switches, a repetition frequency, or a performance time.

10. A system for cleaning an environment, comprising:
at least one self-propelled cleaning device, which has a status detection device configured for detecting an operating status of the cleaning device,
at least one environmental detection device configured for detecting an environmental parameter of the environment,
a computing device configured for defining a working activity to be performed as a function of the detected environmental parameter and/or the detected operating status, and
a database for storing the working activity to be performed,
wherein the system has an input-output interface that communicates with the computing device, and is configured to receive at least one work order relating to a working activity to be performed from a user of the system,
wherein the computing device is configured to analyze a totality of working activities defined based upon the environmental parameters and/or operating status and of work orders received via the input-output interface with respect to a performance time for the working activities to be performed, and to generate a work plan that defines working activities to be manually performed by a user in a specific time period, and output it to the user by means of the input-output interface,
wherein the computing device is configured to filter the totality of working activities, and define a first activity quantity, which comprises at least one working activity that can be automatically performed by the at least one cleaning device, and a second activity quantity, which comprises at least one working activity to be performed exclusively manually by a user.

11. The system according to claim 10, wherein the database has a file that stores reference activities for working activities to be performed manually and reference activities for automatically performable working activities, wherein the computing device is configured to compare a working activity to be performed with the stored reference activities, and given a correlation between the working activity and one of the reference activities, infer a working activity to be performed manually or an automatically performable working activity.

12. The system according to claim 10, wherein the computing device is configured to prompt the user to do a working activity to be exclusively performed manually by means of the input-output interface.

13. The system according to claim 10, wherein the computing device is configured to adjust a second working activity of the cleaning device to be automatically performed as a function of an environmental parameter that was changed based upon a first working activity performed by a user.

14. The system according to claim 10, wherein the computing device is configured to prompt a working activity to be performed manually by a user as a function of the current operating status of the cleaning device, by virtue of the computing device having the input-output interface output a prompt to perform the manual activity.

15. The system according to claim 10, wherein the working activity to be performed manually is a service activity for the cleaning device.

16. The system according to claim 15, wherein the service activity is selected from the group consisting of: providing consumables in the environment, transferring consumables to the cleaning device, receiving material collected by the cleaning device in the environment, freeing the cleaning device from a stalled position, carrying the cleaning device to a base station, and changing or cleaning a component of the cleaning device.

17. The system according to claim 10, wherein the working activity to be performed manually is a cleaning activity for cleaning the environment.

18. The system according to claim 17, wherein the cleaning activity is selected from the group consisting of: cleaning an aboveground surface, cleaning a surface not accessible to the cleaning device.

19. The system according to claim 10, wherein the environmental detection device is configured to detect a currently transpiring use of at least one location in the environment as the environmental parameter.

20. The system according to claim 10, wherein the environmental detection device has at least one sensor selected from the following group: a presence sensor, a motion sensor, a continuity sensor, a location sensor for mobile devices.
